(19) United States
(12) Patent Application Publication
(10) Pub. No.: US 2023/0235971 A1
(43) Pub. Date: Jul. 27, 2023

(54) HEAT STORAGE DEVICE FOR SENSIBLE HEAT STORAGE IN MOLTEN SALTS

(71) Applicant: DEUTSCHES ZENTRUM FÜR LUFT- UND RAUMFAHRT E.V., Bonn (DE)

(72) Inventors: Thomas BAUER, Köln (DE); Freerk KLASING, Köln (DE)

(73) Assignee: DEUTSCHES ZENTRUM FÜR LUFT- UND RAUMFAHRT E.V., Bonn (DE)

(21) Appl. No.: 18/001,645

(22) PCT Filed: May 21, 2021
(86) PCT No.: PCT/EP2021/063710

§ 371 Date: Dec. 13, 2022

(30) Foreign Application Priority Data
Jun. 15, 2020 (DE) 10 2020 115 656.1

(51) Int. Cl. F28D 20/00

(52) U.S. Cl. CPC F28D 20/0039; F28D 2020/0047

(57) ABSTRACT

A heat accumulator device for accumulating sensible heat in molten salts, including: -a heat accumulator vessel for receiving molten salt, a separating layer being disposed in the heat accumulator vessel in order to separate a cold region, in which cold molten salt is present, from a hot region, in which hot molten salt is present, and the cold region being located below the hot region; - a device for loading and unloading the heat accumulator vessel, which device is connected to the cold region and to the hot region; and - a volume compensation device for compensating a temperature-related change in the volume of the molten salt, the volume compensation device interacting with the cold region and/or with the separating layer.

### FIELD

The present invention relates to a heat storage device for sensible heat storage in molten salts.

### BACKGROUND

For storing heat in heat storage systems, in addition to latent heat storage systems and thermochemical heat storage systems, heat storage systems are known that hat perform sensible heat storage.

Heat storage devices for sensible heat storage are known, for example, as so-called liquid salt storage systems in solar thermal power plants. So-called two-tank systems have been implemented on a large scale, in which molten salt heated by solar thermal heating is stored in the so-called hot tank and, in order to discharge the thermal energy, is passed through a heat exchanger into a so-called cold tank. From said cold tank, the cold molten salt is passed through heat exchangers or solar receivers, such as solar tower receivers or parabolic trough receivers, for heating and then stored again in the hot tank. Meanwhile, the temperature remains constant in the respective tank. In such systems, the maximum temperature of the molten salt is limited to approx. 560° C., as otherwise the thermal decomposition of the solar salt is too severe. Solar salt is defined in the literature as a mixture with 60 wt% sodium nitrate and 40 wt% potassium nitrate. During the decomposition of the solar salt, a reaction occurs in the liquid phase and gases are released. The main reactions in the decomposition of the molten salt are a nitrate-nitrite conversion with the release of oxygen and, as temperatures rise, a nitrite-oxide conversion with the release of nitrogen oxides. The release of oxygen is tolerable. However, the toxic nitrogen oxides are to be avoided, as they should not get out of the storage system, but this can only be realized with great effort.

Furthermore, decomposition with nitrogen oxides can lead to an accumulation of oxide ions in the solar salt. The oxide ions can increase the corrosion rate of container materials. Overall, it is therefore desirable to suppress the nitric oxide reaction as far as possible.

A two-tank system also involves a relatively high level of design effort.

In addition to commercial second-tank systems, so-called single-tank systems have also been investigated.

In principle, it is desirable to also store heat at higher temperatures, as this can be used more efficiently during discharge. For this reason, initial investigations have been carried out to increase the temperature of the molten salt to over 560° C.

Overall, the partial pressure of the respective gas phase is decisive for the decomposition of the molten salt. Initial approaches therefore envisage a closed system in which a substantially constant partial pressure of the respective gases is established, which can slow down or reduce further decomposition of the molten salt.

A problem with such closed systems, particularly in the form of two-tank systems, is that a change in volume of both the molten salt and the gas atmosphere above the molten salt in the tank can occur due to the change in temperature during charging and discharging. The liquid salt has a volume increase when heated from 300° C. to 560° C. of approx. 10 vol%. In this temperature range, the gas atmosphere can be subject to a volume change of up to 50%.

In such heat storage tanks, it is also advantageous if they are operated with a maximum overpressure of less than 0.5 bar, since in this case the tanks are not subject to the Pressure Equipment Directive and low wall thicknesses can be used, thus saving design effort and costs.

The technical examples described above are general know-how of the applicant and do not necessarily represent a specific prior art. Moreover, the described systems are not necessarily pre-published.

### SUMMARY

It is an object of the present invention to provide a heat storage device for sensible heat storage of molten salts, which is of simple constructional design and also enables heat storage of molten salts of more than 560° C.

The heat storage device according to the invention for sensible heat storage in molten salts comprises a heat storage reservoir for receiving molten salt, wherein a separating layer is arranged in the heat storage reservoir for separating a cold region, in which cold molten salt is arranged, and a hot region, in which hot molten salt is arranged, wherein the cold region is arranged below the hot region. The heat storage device further comprises a device for charging and discharging the heat reservoir, which is connected to the cold region and the hot region, and a volume compensation device for compensating for a temperature-related change in volume of the molten salt, wherein the volume compensation device cooperates with the cold region and/or the separating layer. The volume compensation device can be used to advantageously compensate for the temperature-related change in volume of the molten salt that occurs during charging and discharging of the heat storage device. In particular, the volume compensation device can be used to ensure that the heat storage reservoir is completely or almost completely filled in the upper area, and thus in the hot region. When charging and discharging the heat storage reservoir, the cold region, the separating layer and the hot region, or at least part of the separating layer and the hot region, always remain, with the separating layer shifting so that the volume occupied by the hot and cold regions is respectively changed. Since there is always a hot region in which hot molten salt is arranged, even in the discharged state of the heat storage reservoir, a may also be allowed above the hot region in the heat storage reservoir. Since the gas atmosphere is always arranged between the upper walls of the heat storage reservoir and the hot region and thus has a constant temperature, there is no change in the volume of the gas atmosphere during charging and discharging of the heat storage reservoir. Thus, it can also be assumed that a constant partial pressure of the gas phase is present, so that a stability of the hot molten salt is given.

However, the heat storage device according to the invention can be operated particularly advantageously if the volume compensation device ensures that no gas atmosphere or only a very small gas atmosphere is formed above the hot region.

The device for charging and discharging the heat storage reservoir can have a charge pump, a so-called cold pump, which is connected to the cold region when the heat storage device is in a discharged state, and a discharge pump, a so-called hot pump, which is connected to the hot region. During charging, cold molten salt is pumped out of the cold region by means of the cold pump and supplied, for example, to solar receivers of a solar thermal power plant. After heating in the solar receivers, the now hot molten salt is introduced into the hot region. When discharging the heat storage device, hot molten salt is pumped out of the hot region by means of the hot pump and supplied to a heat exchanger. The molten salt cooled by means of the heat exchanger is then supplied to the cold region. Due to the corresponding volume changes of the hot and cold regions, the separating layer moves up and down accordingly.

For example, the separating layer can be a natural separating layer, i.e. that it consists of molten salt, wherein in this case there is a natural temperature layer distribution in the heat storage reservoir. The separating layer may also have a floating installation device, for example a separating plate, whereby thermal insulation of the cold region and the hot region can be achieved in an advantageous manner. It may also be provided that a filler material such as a bulk material, which is typically less expensive than the liquid salt, is introduced in the salt volume. The filler material reduces heat conduction and free convection and a stable separation layer can also be formed. The filler material can be, for example, quartzite sand, silica sand, taconite, basalt, burnt red mud, slags or similar. Such filler material has proven to be particularly advantageous, as it can be flowed through by the molten salt and reduce the costs of the inventory. The heat storage reservoir can be a so-called thermocline tank.

In particular, it may be provided that the molten salt is stored in the heat storage reservoir without pressure, i.e. at atmospheric pressure, or at most with a slight underpressure or overpressure of less than +/-0.5 bar. The volume compensation device cooperates directly with the cold region in particular. In particular, it may be provided that the volume compensation device acts on the molten salt arranged in the cold region or in the separating layer.

Preferably, the volume compensation device comprises a compensation reservoir, the compensation reservoir being connected to the cold region in the discharged state of the heat storage device, wherein a compensation fluid is disposed in the compensation reservoir and cooperates with the cold region for volume compensation.

By providing a compensation fluid, the volume compensation can be carried out in a particularly advantageous manner, for example by introducing the compensation fluid into the heat storage reservoir.

It may be provided that the cold region or the separating layer or the separating layer always occupy, for example, at least 5% of the total volume of the heat storage reservoir.

For example, the compensation reservoir can be connected to the heat storage reservoir by means of a fluid line, the fluid line being connected to a bottom area, for example a bottom plate, with the heat storage reservoir, or to a lower lateral wall area of the heat storage reservoir, the lower lateral wall area of the heat storage reservoir extending across maximum 5% of the height of the heat storage reservoir starting from the bottom area.

Preferably, it is provided that the compensation fluid can be introduced into the cold region or the separating layer for volume compensation. In other words: The compensation fluid is directly introduced into the cold molten salt or the molten salt in the separating layer.

Here, it may be provided that the compensation fluid is cold molten salt. This has the advantage that there is no need for separation between the compensation fluid and the molten salt, so that when the heat storage device according to the invention is discharged, wherein the density of the molten salt arranged in the heat storage reservoir increases, the missing volume can be filled by supplying cold molten salt, so that the heat storage reservoir is always completely or almost completely filled with molten salt. When charging the heat storage device according to the invention, wherein the density of the molten salt in the heat storage reservoir decreases, the excess molten salt can be removed from the cold region or the cold region and the separating layer, respectively.

In doing so, it may be provided that the compensation reservoir is arranged above the heat storage reservoir. This has the advantage that, due to the arrangement of the compensation reservoir above the heat storage reservoir, a slight overpressure can be generated in the heat storage reservoir relative to the surroundings, so that the heat storage reservoir has the desired degree of filling, i.e. either completely filled or at least substantially completely filled. The molten salt in the compensation reservoir is thus forced into the heat storage reservoir by gravity and air pressure for volume compensation. Conversely, during discharging, the cold molten salt can be forced back into the compensation reservoir.

In this respect, it is preferably provided that, when the heat storage device is in the discharged state, the compensation reservoir is connected to the cold region via a riser.

In a preferred embodiment, it is provided that the device for charging and discharging the heat storage device is connected to the cold region via the compensation reservoir when the heat storage device is in the discharged state. In other words: The compensation reservoir can be provided as part of the device for charging and discharging the heat storage reservoir, so that during charging and discharging the corresponding volume compensation is effected by supplying the correspondingly necessary volumes of cold molten salt to the heat storage reservoir via the device for charging and discharging by means of the compensation reservoir or by removing it therefrom, respectively.

In doing so, it may be provided that the device for charging and discharging the heat storage reservoir has a discharge pump connected to the hot region or arranged in the hot region and a charge pump connected to the compensation reservoir or arranged in the compensation reservoir.

Such an arrangement has proved to be particularly advantageous, since, for example, the hot pump can be designed with a relatively short pump shaft, which means that pump costs can be kept low and, in addition, the restriction on the overall height of the heat storage reservoir due to limited realisable pump shaft lengths is eliminated. For example, the compensation reservoir can be designed as a cold salt basin so that atmospheric pressure is applied to the surface of the cold salt. If a connection is provided between the compensation reservoir and the cold region via a riser, the charge pump can also be equipped with a short pump shaft, since the cold molten salt enters the compensation reservoir from the cold region via the riser, so that the charge pump only has to draw in cold molten salt from the compensation reservoir.

In operation, it can also be provided in principle that part of the molten salt in the separating layer is removed from the heat storage reservoir when charging the heat storage device, so that at the end of the charging process the volume compensation device, e.g. the compensation reservoir, is correspondingly connected to the separating layer.

The compensation reservoir can also be connected to a further storage reservoir, which can be a so-called cold tank, wherein the compensation reservoir is connected to the further storage reservoir via an overflow. Thus, the compensation reservoir can be relatively small, since excess cold molten salt can enter the further heat storage reservoir via the overflow. By means of a further pump, the cold molten salt contained in the further storage reservoir can be supplied back into the system. The further storage reservoir can have at least the same volume as the heat storage reservoir, for example, so that the further storage reservoir is also suitable for receiving the entire molten salt, so that the heat storage reservoir can be completely emptied for inspection purposes.

In another embodiment of the heat storage device according to the invention, it may be provided that the compensation fluid is a gas. Since the molten salt used is a major cost factor in systems with heat storage devices, and in the previously described heat storage device in which the compensation fluid is cold molten salt, a certain amount of molten salt is thus always unused, using a gas as a compensation fluid has cost advantages.

In this respect, it is preferably provided that a gas retention device is arranged in the heat storage reservoir, which retains the gas in a predetermined section in the heat storage reservoir after it has been introduced into the cold region or into the separating layer. For example, the gas retention device may be in the form of a plate, such as a curved plate, or a plate having a protruding side edge projecting downwardly from the plate. When the compensation fluid in the form of gas is introduced into the cold region, it traps below the gas retention device so that it remains in this position. When the gas is introduced, it forces the cold molten salt out from under the gas retention device. When the heat storage device according to the invention is charged, the gas is forced back into the compensation reservoir by the cold molten salt. Here, it is advantageous if the compensation reservoir is connected to the cold region by a fluid line, with the fluid line opening into the heat storage reservoir directly below the gas retention device. In this manner, the compensation fluid in the form of gas can be advantageously introduced into and removed from the cold region. The gas retention device can extend from the lower lateral wall region towards the interior of the heat storage reservoir.

The gas retention device in the form of a plate can disturb the temperature stratification in the heat storage reservoir. Therefore, additional devices may be provided in order to stabilize the stratification. For example, an additional diffuser can be provided at the edge region of the gas retention device, through which the stratification is maintained. For example, the gas retention device may circumferentially rest on the wall of the heat storage reservoir and may extend only in one or more sections spaced from the wall to form one or more passages. At the passage or passages, the gas retention device may have the protruding side edge, respectively. Also, the gas retention device may have the diffuser on each of the passage or passages.

It may be provided that the compensation reservoir has a connection to the atmosphere, wherein gas forced out of the heat storage reservoir can be transferred to the atmosphere in the event of temperature-related expansion of the molten salt. The compensation system comprising the compensation reservoir is thus designed as a semi-open system. In the discharging process, the gas can be provided to the compensation reservoir by means of a corresponding gas supply, for example. Unlike the gas phase in the hot region of the storage, the gas phase in the cold region or separating layer of the storage can be substantially free of nitrogen oxides, allowing direct exchange with the environment. Due to the relatively low temperature of the gas, the thermal losses occurring during discharge to the atmosphere are manageable. Furthermore, design requirements for the compensation reservoir and the gas lines connected thereto are relatively low, as these are exposed to relatively low temperatures and relatively small nitrogen oxide pollution.

For example, it may be provided that the compensation reservoir is connected to the atmosphere via a pressure relief valve and to the gas supply via a vacuum valve, so that when the system is charged, with gas being forced into the compensation reservoir, it can be transferred to the atmosphere by means of the pressure relief valve, if necessary. When the heat storage reservoir is discharged, a vacuum is created so that the vacuum valve is opened, allowing the necessary gas to flow into the compensation reservoir.

Instead of a pressure relief valve and a vacuum valve, it is also possible to provide control valves so that a controller controls the discharge of gas to atmosphere and the introduction of gas from the gas supply into the compensation reservoir.

Semi-open systems have the advantage that the compensation reservoir can be relatively small, since it does not have to receive the entire volume of gas required for volume compensation.

It may also be provided that a volume changing device is arranged on the compensation reservoir for changing the volume of the gas. In other words: When it is necessary for the volume compensation device to introduce gas into the heat storage reservoir, the volume changing device increases the volume of the gas and thus decreases the density of the gas. If, during the charging process, the gas is returned from the heat storage reservoir to the compensation reservoir, a reduction in the gas volume and thus an increase in density occurs via the volume changing device. This can be done, for example, by the volume changing device having a heating element and/or a cooling device, wherein the temperature of the gas can be changed by means of the heating element and/or the cooling device to change the volume. In other words: The volume changing device thermally performs the necessary density change of the gas.

For a thermal density and thus volume change of the gas, it may also be provided that the compensation reservoir is connected to a thermal energy storage, for example a regenerator storage, which supplies heat to the gas or extracts heat from the gas, whereby the volume can be changed via the temperature of the gas. The gas can thus be heated or cooled by means of the thermal energy storage.

In addition to a thermal volume change of the gas, a mechanical volume change of the gas is also possible in that the volume changing device has a device for mechanically changing the volume of the gas. This device may include, for example, a blower, compressor, turbine, compactor, or the like.

It is also possible that the compensation reservoir has a variable volume. In this respect, it can be provided, for example, that the compensation reservoir has an elastic, movable or flexible wall or an elastic, movable or flexible wall section. In a charging process of the heat storage reservoir, the gas is forced into the compensation reservoir and, for example, a movable wall or a flexible wall is pressed outward or an elastic wall is pressed outward and stretched accordingly. In the discharging process of the heat storage reservoir, the gas is removed from the compensation reservoir and the elastic, movable or flexible wall is moved back to the previous position. In the exemplary embodiment of a movable wall or a movable wall section, it is particularly possible for the wall or wall section to be displaceable. In principle, it is possible that the flexible or movable wall or the flexible or movable wall section can be driven, for example by means of an active drive or a passive drive, such as an elastic element like a spring or the like. The active drive can, for example, press the movable or flexible wall in such a way that the volume in the compensation reservoir is reduced, so that the gas is forced into the cold region of the heat storage reservoir during the discharging process of the heat storage reservoir. For example, when providing an elastic member on the flexible or movable wall, the elastic member may be compressed when the gas is forced into the compensation reservoir during the charging process of the heat storage reservoir, and during the discharging process of the heat storage reservoir, the elastic member may reform and thus press back the flexible or movable wall so that the gas is forced out of the compensation reservoir.

In the heat storage device according to the invention, it may also be provided that the volume compensation device has a compensation chamber in the cold region or the separating layer, respectively, the compensation chamber having a variable volume, wherein the compensation fluid can be introduced into the compensation chamber. The compensation chamber with the variable volume may have, for example, an elastic, movable or flexible wall or an elastic, movable or flexible wall section. When the heat storage reservoir is discharged, the compensation chamber expands as the compensation fluid is introduced for volume compensation in the heat storage reservoir. When the heat storage reservoir is charged, the compensation chamber is compressed, for example, so that the compensation fluid leaks from the compensation chamber. The movable wall or the movable wall section, respectively, of the compensation chamber can be displaceable, in particular.

In the heat storage device according to the invention, it may also be provided that the heat storage reservoir has a movable wall or a movable wall section. For example, the bottom of the heat storage reservoir can be movable and, for example, can be moved, in particular displaced, by means of a drive device. Thus, the volume compensation device effects a volume change of the heat storage reservoir in which the movable wall or the movable wall section is moved to change the volume.

### BRIEF DESCRIPTION OF THE FIGURES

In the following, the invention is described in more detail with reference to the following figures. In the drawings:

FIG. 1 is a schematic sectional view of a heat storage device according to the invention,

FIG. 2a shows the heat storage device of FIG. 1 in the charged state,

FIG. 2b shows the heat storage device of FIG. 1 in the discharged state,

FIG. 3 is a schematic view of a second exemplary embodiment of the heat storage device according to the invention,

FIG. 4a is a schematic view of the third exemplary embodiment of a heat storage device according to the invention in a charged state,

FIG. 4b is a schematic view of the third exemplary embodiment of a heat storage device according to the invention in a discharged state,

FIG. 5a is a schematic view of the volume compensation device of the exemplary embodiment of the FIG. 4a.

FIG. 5b is a schematic view of the volume compensation device of the exemplary embodiment of the FIG. 4a.

FIG. 5c is a schematic view of the volume compensation device of the exemplary embodiment of the FIG. 4a.

FIG. 6a is a schematic view of the volume compensation device of the exemplary embodiment of the FIG. 4b.

FIG. 6b is a schematic view of the volume compensation device of the exemplary embodiment of the FIG. 4b.

### DETAILED DESCRIPTION

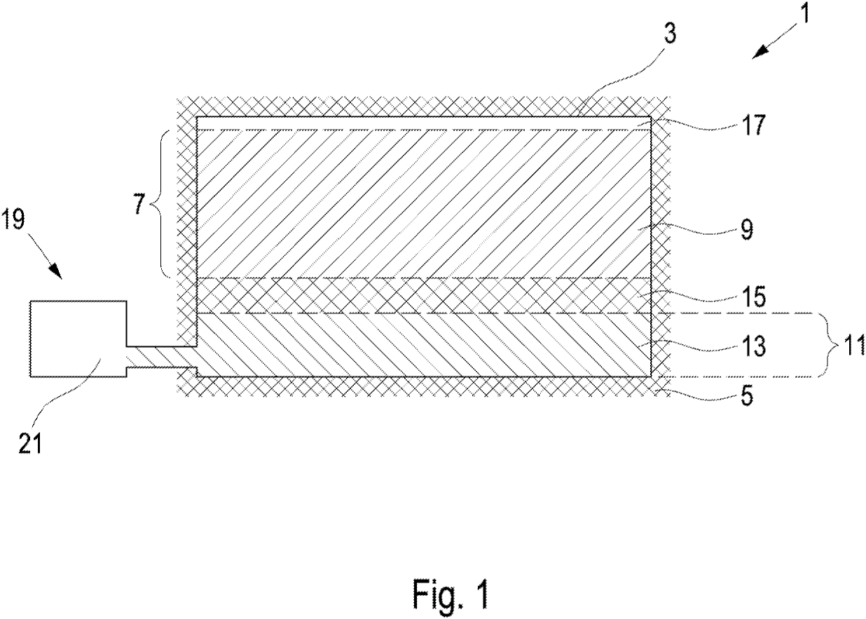

In FIG. 1, a heat storage device 1 according to the invention in schematically shown in a sectional view. Since only the principle of the heat storage device 1 according to the invention is to be illustrated initially on the basis of FIG. 1, some partial areas of the heat storage device 1 according to the invention have not been illustrated.

The heat storage device 1 has a heat storage reservoir 3 formed as a tank, for example. The heat storage device 1 according to the invention serves for heat storage of sensible heat in molten salts and can be used, for example, for heat storage of thermal energy of a solar power plant.

The heat storage reservoir 3 of the heat storage device 1 according to the invention is designed as a so-called single-tank system, in which three different temperature layers of the molten salt located in the reservoir are present in the heat storage reservoir 3. Said tank is a tank according to the so-called thermocline principle.

For example, the heat storage reservoir 3 is a flat-bottom tank and surrounded by an insulating layer 5.

In the heat storage reservoir 3, the molten salt forms a so-called hot region 7, in which hot molten salt 9 is arranged, and a cold region 11, in which cold molten salt 13 is arranged. Hot molten salt is understood to be molten salt up to approx. 620° C. Cold molten salt is in the range of 300° C. Both the hot and cold molten salt are always liquid. The cold region 11 is arranged below the hot region 7. The hot region 7 is separated from the cold region 11 by a separating layer 15, wherein the separating layer 15 can be formed as a natural separating layer, i.e. also of molten salt. The separation layer 15 may also have appropriate fittings, such as a floating separating plate.

In the exemplary embodiment shown in FIG. 1, a thin gas layer 17 is formed above the hot region 7. In principle, however, the aim is to operate the heat storage device 1 according to the invention in such a way that the heat storage reservoir 3 is completely or almost completely filled with molten salt.

A non-illustrated device for charging and discharging the heat storage reservoir 3 removes hot molten salt 9 from the hot region 7 for discharging, with cooled cold molten salt 13 being introduced into the cold region 11. When charging the heat storage device 1 according to the invention, cold molten salt 13 is removed from the cold region 11 and introduced into the hot region 7 after heating. During charging and discharging, the separating layer 15 thus moves up and down accordingly in the heat storage reservoir 3.

Since hot molten salt 9 has a low density and thus a larger volume than the cold molten salt 13, it is necessary to compensate for the volume in the heat storage reservoir 3 in order to keep the thin gas layer 17 as constant as possible or to keep the heat storage reservoir 3 completely filled with molten salt.

Therefore, the heat storage device 1 according to the invention comprises a volume compensation device 19. The volume compensation device 19 has a compensation reservoir 21 which is connected to the cold region 11 in the illustrated state. A compensation fluid is arranged in the compensation reservoir 21, said compensation fluid cooperating with the cold molten salt 13 in the cold region 11 for volume compensation. In the exemplary embodiments illustrated in FIGS. 1-3, the compensation fluid is cold molten salt.

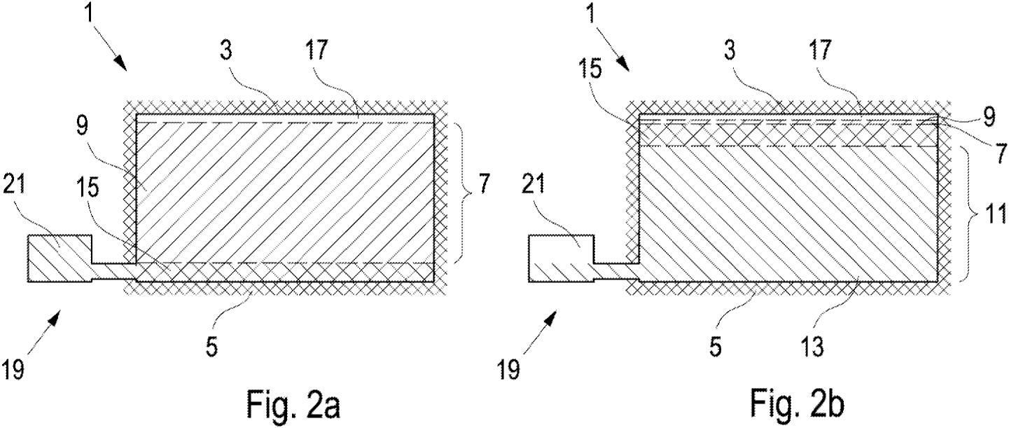

In FIGS. 2a and 2b, the function of the heat storage device 1 according to the invention as shown in FIG. 1 can be explained in more detail based on the charged state (FIG. 2a) and the discharged state (FIG. 2b).

In FIG. 2a, the heat storage reservoir 3 is shown in the charged state so that the heat storage reservoir 3 is almost completely filled with hot molten salt 9. Thus, the hot region 7 occupies the largest part of the heat storage reservoir 3. The cold region 11 is only present as a thin lower layer or has been completely removed from the heat storage reservoir 3. Since the hot molten salt 9 in the heat storage device 1 according to the invention has a low density compared to the cold molten salt 13, a larger volume is required for the hot molten salt 9. Thus, the compensation fluid in the form of cold molten salt is forced into the compensation reservoir 21 of the volume compensation device 19. After discharging the heat storage device 1 according to the invention (FIG. 2b), a large part of the heat storage reservoir 3 is filled with cold molten salt 13, so that the cold area 11 accordingly occupies a large proportion in the heat storage reservoir 3. Only a thin layer of hot molten salt 9 is arranged above the cold region 11, so that a correspondingly thin section forms the hot region 7.

Since the cold molten salt 13 has a greater density than the hot molten salt 9, the cold molten salt 13 occupies a smaller volume in the heat storage reservoir 3, so that the heat storage reservoir 3 would not be completely filled, wherein the supply of cold molten salt by the volume compensation device compensates for the missing volume. Accordingly, the compensation reservoir is largely empty.

As can be seen from FIGS. 2a and 2b, any thin gas layer 17 present in the heat storage reservoir 3 is always in contact with the hot region 7, so that the gas layer 17 has a constant temperature substantially equal to the temperature of the hot molten salt 9. As a result, there is no temperature-related change in the volume of the gas layer 17 during either charging or discharging of the heat storage device 1. Furthermore, the heat storage device 1 according to the invention is designed as a substantially closed system, so that at least the area in which the hot molten salt 9 is arranged is closed off from the atmosphere in order to reduce or prevent decomposition and outgassing of the hot molten salt 9.

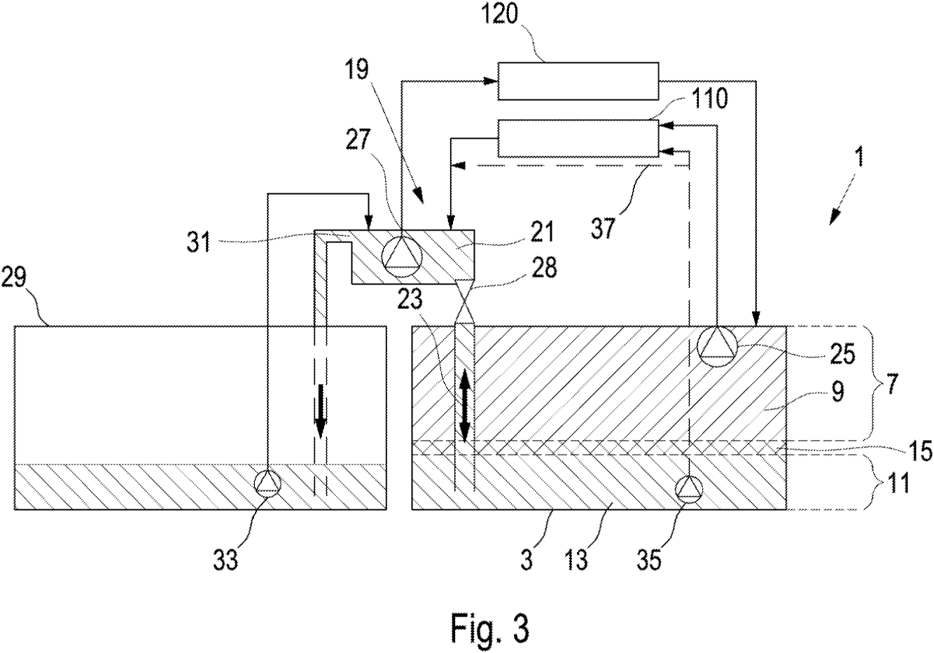

In FIG. 3, a heat storage device 1 according to the invention is schematically shown in a second embodiment. The heat storage device 1 according to the invention is constructed similarly to the heat storage device 1 shown in FIG. 1. The essential difference to the heat storage device 1 shown in FIG. 1 is that the compensation reservoir 21 of the volume compensation device 19 is arranged above the heat storage reservoir 3. In this case, the compensation reservoir 21 is formed as a basin so that there is a connection to the atmosphere. The compensation reservoir 21 is connected to the cold region 11 via a riser 23. In FIG. 3, the device for charging and discharging the heat storage reservoir 3 is also illustrated. The device for charging and discharging the heat storage reservoir 3 has a discharge pump 25 arranged in the hot region 7. Moreover, the device for charging and discharging the heat storage reservoir 3 has a charging pump 27 arranged in the compensation reservoir 21. The compensation reservoir 21 is thus arranged in the circuit for charging the heat storage device 1. When fully charged, the cold region 11 can also be fully pressed into the compensation reservoir 21 so that the riser 23 is then connected to the separating layer 15 in the charged state.

The riser 23 is connected to the compensation reservoir 21 via a valve 28. In the discharging process, hot molten salt 9 is supplied to a discharging process 110 by means of the discharge pump 25. The cold molten salt cooled by the discharging process is supplied to the compensation reservoir 21 and, when the valve 28 is open, passes through the riser 23 into the cold region 11 due to the atmospheric pressure acting on the cold molten salt in the compensation reservoir 21.

When charging the heat storage device 1 according to the invention, the cold molten salt from the compensation reservoir 21 is supplied by means of the charge pump 27 to a charging process 120, which can be carried out by a solar thermal power plant, for example. The heated molten salt is supplied to the hot region 7. The hot molten salt 9 in the hot region 7 presses down the separating layer 15 so that cold molten salt 13 from the cold region 11 is forced through the riser 23 into the compensation reservoir 21 with the valve 28 open.

The embodiment shown in FIG. 3 has the particular advantage that the discharge pump 25 and the charge pump 27 can be designed cost-effectively, since they require only a very short pump connection.

As shown in FIG. 3, another reservoir 29 can be arranged next to the heat storage reservoir 3. Said further reservoir can be connected to an overflow 31 of the compensation reservoir 21 so that excess cold molten salt can pass through the overflow 31 into the further reservoir 29. This allows the compensation reservoir 21 to be designed with a relatively small volume. In the discharging process, cold molten salt can be pumped into the compensation reservoir 21 by means of an additional pump 33.

The further reservoir 29 can have a size adapted to the heat storage reservoir 3 so that the further reservoir 29 can also be used for emptying the heat storage reservoir 3 for inspection or repair purposes. For this purpose, a drain pump 35 is provided in the heat storage reservoir 3, which is connected to the compensation reservoir 21 via a return line.

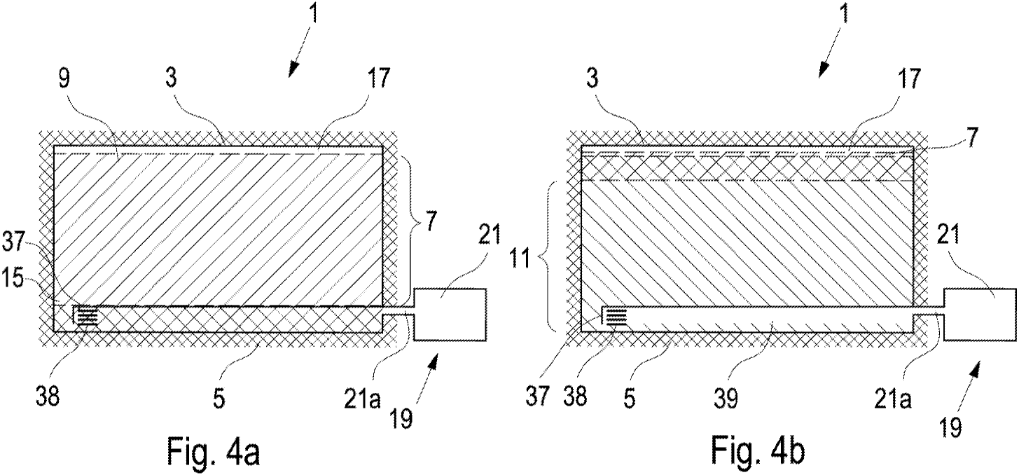

In FIGS. 4a and 4b, a third exemplary embodiment of the heat storage device 1 according to the invention is shown schematically in a sectional view, with FIG. 4a illustrating a charged state and FIG. 4b a discharged state. FIGS. 4a and 4b are comparable to FIGS. 2a and 2b.

The substantial difference between the third exemplary embodiment show in FIGS. 4a and 4b and the first exemplary embodiment shown in FIGS. 2a and 2b of the heat storage device 1 according to the invention is the type of compensation fluid. While cold molten salt is used as compensation fluid in FIGS. 2a and 2b, a gas is used as compensation fluid in the third exemplary embodiment shown in FIGS. 4a and 4b. A gas is thus disposed in the compensation reservoir 21, which gas the volume compensation device 19 can introduce into the heat storage reservoir 3 for volume compensation. Furthermore, a gas retention device 37 is arranged in the heat storage reservoir 3, which may be designed as a plate with a beveled edge. As can be seen from FIG. 4b, the gas 39 introduced into the heat storage reservoir 3 for volume compensation is held in a predetermined section in the separating layer 15 by the gas retention device 37. The use of gas as a compensation fluid has the advantage that the gas is significantly cheaper than the solar salt used for molten salt. Since the compensation fluid in the form of molten salt cannot be used for heat storage, the use of molten salt as a compensation fluid has a cost disadvantage.

As can be seen from FIGS. 4a and 4b, the cold molten salt 13 in the charged state can also enter the section where the gas 39 is disposed in the discharged state by forcing the cold molten salt 13 under the gas retention device 37. In order to reliably ensure that the gas 39 is introduced into and discharged from the heat storage reservoir 3, a supply line 21a, which connects the compensation reservoir 21 to the cold region 11 or the separating layer 15, respectively, is arranged directly below the gas retention device 37.

As can be seen from FIG. 4a, the separating layer 15, which in the exemplary embodiment shown in FIGS. 4a and 4b is formed as a natural separating layer by molten salt, is pressed under the gas retention device 37. To avoid mixing of the layers during this process, it may be provided that additional fittings are provided on the gas retention device 37 to stabilize the stratification, such as a diffuser 38. The diffuser 38 ensures that stratification can build up below the gas retention device 37 and that there is no exergetically unfavorable mixing.

As part of the discharging process of the heat storage device 1 according to the invention, the gas 39 must be introduced from the compensation reservoir 21 into the heat storage reservoir 3. For this purpose, it is necessary that a pressure is generated in the compensation reservoir 21 which forces the gas 39 into the heat storage reservoir 3, since the gas below the gas retention device 37 is subject to hydrostatic pressure due to the liquid salt column above it.

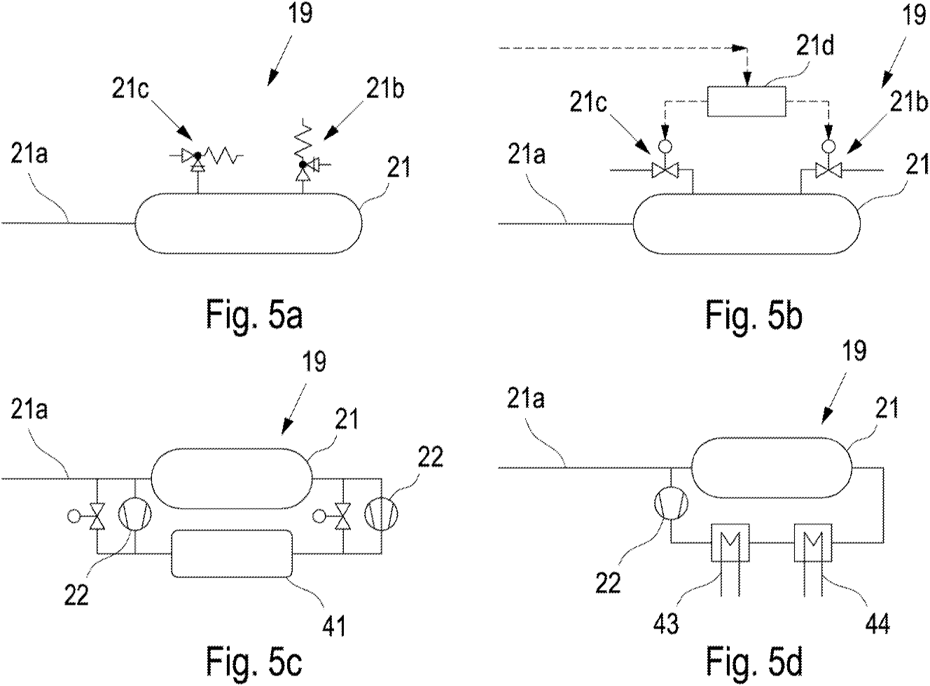

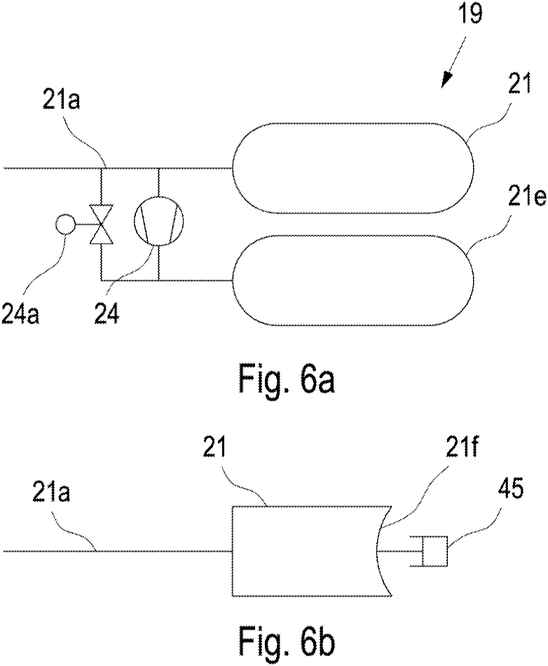

FIG. 5a-6 show different examples of devices of the volume compensation device 19, by means of which a corresponding pressure for the gas can be adjusted.

FIGS. 5a and 5b show a so-called semi-open system. The gas transferred from the heat storage reservoir 3 through the conduit 21a into the compensation reservoir 21 can be discharged to the atmosphere by means of an outlet valve 21b. In the exemplary embodiment shown in FIG. 5a, the outlet valve 21b is designed as a pressure relief valve. In the exemplary embodiment shown in FIG. 5b, the outlet valve 21b is designed as a control valve.

When the gas is introduced into the heat storage reservoir 3 as part of the discharging process of the heat storage device 1 according to the invention, gas is supplied to the compensation reservoir 21 by means of an inlet valve 21c. In the exemplary embodiment shown in FIG. 5a, the inlet valve 21c is designed as a vacuum valve. In the exemplary embodiment shown in FIG. 5b, the inlet valve 21c is illustrated as a control valve. In the exemplary embodiment shown in FIG. 5b, the controllable outlet valve 21b and the controllable inlet valve 21c are controlled by a controller 21d.

In the exemplary embodiment shown in FIGS. 5c and 5d, the pressure for the gas in the compensation reservoir 21 is thermally generated by causing a change in density and thus a change in volume of the gas by heating or cooling the gas.

In the exemplary embodiment shown in FIG. 5c, the gas can be transferred from the compensation reservoir 21 by means of a blower 22 into a regeneration storage 41, in which the gas is heated or cooled, thereby causing a change in density and volume of the gas.

In the exemplary embodiment shown in FIG. 5d, the gas from the compensation reservoir 21 can be supplied by means of a blower 22 to a heating device 43 and a cooling device 44, thereby causing a corresponding change in temperature and thus a change in density and volume of the gas.

In addition to thermal pressure generation for introducing the gas into the heat storage reservoir 3, mechanical pressure generation is also possible.

FIG. 6a shows an exemplary embodiment in which the volume compensation device has a second compensation reservoir 21e in addition to the compensation reservoir 21, wherein gas at increased pressure can be transferred into the second compensation reservoir 21e by means of a compressor 24. A control valve 24a allows the compressed gas from the second compensation reservoir 21e to be transferred at an increased pressure into the line 21a and thus into the heat storage reservoir 3.

In FIG. 6b, a volume change occurs in a mechanical way, while the gas pressure remains constant. The compensation reservoir 21 has a flexible wall 21f that can be moved by a drive device 45, which allows the volume in the compensation reservoir 21 to be changed. When gas is to be introduced into the heat storage reservoir 3, the drive device 45 presses the flexible wall 21f into the compensation reservoir 21 so that the volume of the compensation reservoir 21 is reduced and the gas is forced from the compensation reservoir 21 through the conduit 21a into the heat storage reservoir 3. Conversely, the flexible wall 21f can also be pulled out of the compensation reservoir 21 by the drive device 45 so that the volume of the compensation reservoir 21 is increased. Since the gas is forced out of the heat storage reservoir 3 when the heat storage device 1 according to the invention is charged, little or no effort is required for moving the flexible wall 21f to increase the volume of the compensation reservoir 21. Therefore, instead of the drive device 45, a spring device may also be provided, for example, which is compressed when gas is introduced into the compensation reservoir 21 and the flexible wall 21f is correspondingly deformed, and which compresses the flexible wall 21f accordingly to introduce the gas into the heat storage reservoir 3. The flexible wall 21f can be in the form of a bellows.

The heat storage device 1 according to the invention has the particular advantage that there is no or only a small volume of gas above the hot molten salt 9, so that the tendency of the salt to decompose is reduced and only slight or no outgassing occurs or increased operating temperatures are made possible, respectively. In this regard, the heat storage reservoir 3 of the heat storage device 1 according to the invention can be operated with an internal pressure that has a difference of less than 500 mbar with respect to the atmosphere, so that the heat storage reservoir 3 is not subject to the Pressure Equipment Directive. If there is a gas phase above the hot region, it has a substantially constant temperature during operation so that no volume compensation is necessary for a volume change of the gas. In this way, the heat storage device 1 according to the invention enables particularly advantageous heat storage in the molten salt.

List of reference numerals

| | |
|---|---|
| 1 | heat storage device |
| 3 | heat storage reservoir |
| 5 | insulating layer |
| 7 | hot region |
| 9 | hot molten salt |
| 11 | cold region |
| 13 | cold molten salt |
| 15 | separating layer |
| 17 | gas layer |
| 19 | volume compensation device |
| 21 | compensation reservoir |
| 21 a | supply line |
| 21 b | outlet valve |
| 21 c | inlet valve |
| 21 d | controller |
| 21 e | second compensation reservoir |
| 21 f | flexible wall |
| 22 | blower |
| 23 | riser |
| 24 | compressor |
| 24 a | control valve |
| 25 | discharge pump |
| 27 | charge pump |
| 28 | valve |
| 29 | reservoir |
| 31 | overflow |
| 33 | additional pump |
| 35 | drain pump |
| 37 | gas retention device |
| 38 | diffuser |
| 39 | gas |
| 41 | regeneration storage |
| 43 | heating device |
| 44 | cooling device |
| 45 | driving device |
| 120 | charging process |
| 110 | discharging process |

1-19. (canceled)

20. A heat storage device for sensible heat storage in molten salts comprising a heat storage reservoir for receiving molten salt, wherein a separating layer is arranged in the heat storage reservoir for separating a cold region, in which cold molten salt is arranged, and a hot region, in which hot molten salt is arranged, wherein the cold region is arranged below the hot region, comprising a device for charging and discharging the heat storage reservoir, which is connected to the cold region and the hot region, and comprising a volume compensation device for compensating for a temperature-related volume change of the molten salt, wherein the volume compensation device cooperates with the cold region and/or the separating region.

21. The heat storage device according to claim 20, wherein the volume compensation device comprises a compensation reservoir, wherein the compensation reservoir is connected to the cold region and/or the separating region, and wherein a compensation fluid is disposed in the compensation reservoir and cooperates with the cold region and/or the separating layer for volume compensation.

22. The heat storage device according to claim 21, wherein the compensation fluid can be introduced into the cold region and/or the separating layer for volume compensation.

23. The heat storage device according to claim 22, wherein the compensation fluid is cold molten salt.

24. The heat storage device according to claim 23, wherein the compensation reservoir is arranged above the heat storage reservoir and is connected to the cold region via a riser.

25. The heat storage device according to claim 23, wherein the device for charging and discharging the heat storage reservoir is connected to the cold region via the compensation reservoir.

26. The heat storage device according to claim 25, wherein the device for charging and discharging the heat storage reservoir has a discharge pump connected to the hot region or arranged in the hot region and a charge pump connected to the compensation reservoir or arranged in the compensation reservoir.

27. The heat storage device according to claim 22, wherein the compensation fluid is a gas.

28. The heat storage device according to claim 27, wherein a gas retention device is arranged in the heat storage reservoir, which retains the gas in a predetermined section in the heat storage reservoir after it has been introduced into the cold region or into the separating layer.

29. The heat storage device according to claim 27, wherein a gas retention device is formed as a plate having a side edge projecting downwardly, wherein a diffuser is arranged at the edge region of the gas retention device to stabilize the stratification in the molten salt.

30. The heat storage device according to claim 27, wherein the compensation reservoir has a connection to the atmosphere, wherein the gas can be transferred to the atmosphere in the event of temperature-related expansion of the molten salt.

31. The heat storage device according to claim 27, wherein a volume changing device is arranged on the compensation reservoir for changing the volume of the gas.

32. The heat storage device according to claim 31, wherein the volume changing device has a heating element and/or a cooling device, wherein the temperature of the gas can be changed by means of the heating element and/or the cooling device to change the volume.

33. The heat storage device according to claim 31, wherein the volume changing device has a thermal energy storage on the compensation reservoir by means of which the gas can be heated of cooled.

34. The heat storage device according to claim 31, wherein the volume changing device has a device for mechanical volume change of the gas.

35. The heat storage device according to claim 27, wherein the compensation reservoir has a variable volume.

36. The heat storage device according to claim 35, wherein the compensation reservoir has an elastic, movable or flexible wall or an elastic, movable or flexible wall section.

37. The heat storage device according to claim 20, wherein the volume compensation device has a compensation chamber in the cold region with a variable volume, wherein the compensation fluid can be introduced into the compensation chamber.

38. The heat storage device according to claim 20, wherein the heat storage reservoir has a movable wall or a movable wall section.
